(19) United States
(12) Patent Application Publication
(10) Pub. No.: US 2013/0299291 A1
(43) Pub. Date: Nov. 14, 2013

(54) VALVE ARRANGEMENT

(71) Applicants: Benny Ewers, Upplands Vasby (SE); Lars Sonsterod, Upplands Vasby (SE); Hakan Malmborg, Upplands Vasby (SE)

(72) Inventors: Benny Ewers, Upplands Vasby (SE); Lars Sonsterod, Upplands Vasby (SE); Hakan Malmborg, Upplands Vasby (SE)

(73) Assignee: OHLINS RACING AB, Upplands Vasby (SE)

(21) Appl. No.: 13/880,491

(22) PCT Filed: Oct. 21, 2011
(86) PCT No.: PCT/EP2011/068436

§ 371 Date: Jul. 29, 2013

(30) Foreign Application Priority Data
Oct. 22, 2010 (EP) 10188594.5

(51) Int. Cl. F16F 9/34

(52) U.S. Cl. CPC F16F 9/34
USPC 188/322.13

(57) ABSTRACT

A valve arrangement controls a main flow of damping medium in a shock absorber between two chambers. The valve arrangement has an actuator positioned in an actuator chamber that is in fluid communication with the two chambers. A pilot valve has a pilot chamber that is in fluid communication with the actuator chamber. A restrictor arrangement restricts flow from the actuator chamber to the pilot chamber. A sub-valve cooperating with the restrictor arrangement to control flow between two flow paths.

This application is a national stage application under 35 U.S.C. §371 of PCT Application No. PCT/EP2011/068436 designating the United States, filed Oct. 21, 2011. The PCT Application was published in English as WO 2012/052546 A1 on Apr. 26, 2012 and claims the benefit of European Patent Application EP 10188594.5, filed on Oct. 22, 2010.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND OF THE INVENTION

1. Field of the Invention

The present invention relates to a valve arrangement for controlling a main flow of damping medium in a shock absorber from a first chamber to a second chamber during a first stroke and from the second chamber to the first chamber during a second stroke.

2. Description of the Related Art

Generally, within the technical field of shock absorbers that include pilot valves, a pressure regulator, i.e. a valve arrangement, is used to control a flow of damping medium between a compression chamber and a rebound chamber during a reciprocal motion of a piston in a damping medium filled chamber of the shock absorber. The piston, via a piston rod, is connected either to a wheel or a chassis, whereas the rebound chamber is connected to the one of the wheel or chassis that the piston is not connected to. During a compression stroke, the piston moves in a direction towards the compression chamber and thereby pressurizes the damping medium in the compression chamber. During a rebound stroke, the piston moves towards the rebound chamber, i.e. in the opposite direction, and thereby pressurizes the damping medium in the rebound chamber. In accordance with the function of the shock absorber, the pressurized damping medium needs to be transferred from the pressurized chamber to the other chamber, i.e. from the compression chamber to the rebound chamber or vice versa. The flow of damping medium needs to be controlled to obtain a damping effect of the piston and thus the shock absorber, i.e. to damp relative motion between the wheel and chassis.

The control of the pressure in the flow of damping medium in the shock absorber depends on the pressure created by the pilot valve due to the speed of movement of the piston. Pressure regulators in shock absorbers are usually provided with a movable adjustment part, such as a washer or a cone that acts against a seat part. The pressure control is achieved by an equilibrium of forces on the movable adjustment part between a regulator force and supplemental opposing forces, such as one or more of a spring force, flow force, valve damping force, friction force or pilot pressure force. When the piston of the shock absorber moves at a speed such that the regulator forces become greater than the opposing forces, the movable adjustment part is forced to open. Thus, the movable adjustment part is forced to open at a stroke defined as a function of the flow produced by the pressure acting on the regulating area of the pressure regulator.

In a simple form of a pressure regulator, see FIG. 1, a valve member in the form of a plane washer, cone, or the like rests against a seat. The pressure regulator has a regulating area dependent only on one diameter d1′, defined as the area subjected to a regulator pressure due to flow of damping medium. Thus, the pressure regulator includes a valve member which, at various degrees, opens and closes an opening of a channel which fluidly interconnects two volumes, i.e. the compression and rebound chamber volumes, and an actuator which resiliently exerts an actuating force on the valve member. The actuator may itself be a resilient force exerting element or may constitute a passive element upon which the resilient force exerting element exerts the resilient force. The regulator force can be defined as the regulator pressure p1 times the regulator area. The flow moves past the washer and is throttled by curtain areas As1′, defined by the stroke s′ and the diameter d1′. This variant of pressure regulator thus opens at a regulator force value and is kept open as long as the regulator force is at or above this regulator force value. The pressure regulator increases its stroke s when Fr is bigger than Fa but does not increase or decrease its stroke s when Fa is biasing Fr, that is Fa=Fr. When Fr is lower than Fa the regulator is closing, reducing its stroke s. In the pressure regulator's closed position Fr can be lower than Fa without any change of position when s=0. Thus, the pressure regulator abruptly opens at a predetermined pressure difference across the washer, determined by the regulator force Fr and the opposing forces, i.e. the actuating forces, which can be a total opposing force Fa, created by either or all of the spring forces Fs, pilot forces Fp, and other flow and friction forces Fq.

However, during dynamical events during the operation of the shock absorber, the regulator force and the total opposing force may reciprocally interact in an oscillating manner which, in turn, would affect the valve member and the acting actuator. This may cause unwanted oscillation or self-oscillation of the parts of the shock absorber which, in turn, may generate unwanted noise and/or may cause discomfort to passengers in the vehicle. In addition to this, an inherent property of the resilient force exerting element is that it may oscillate or self-oscillate which would contribute to the unwanted noise and/or discomfort. Thus, one problem with such pressure regulators is that such pressure regulators may generate unwanted noise in the vehicle.

### SUMMARY OF THE INVENTION

An object of certain embodiments is to provide an improved valve arrangement for controlling a main flow of damping medium in a shock absorber from a first chamber to a second chamber during a first stroke and from the second chamber to the first chamber during a second stroke.

This and other objects are achieved by providing a valve arrangement having the features defined in the independent claim. Preferred embodiments are defined in the dependent claims.

Certain embodiments provide a valve arrangement for controlling a main flow of damping medium in a shock absorber from a first chamber to a second chamber during a first stroke and from the second chamber to the first chamber during a second stroke. The valve arrangement comprises a first actuator having a first actuator chamber communicating with said first chamber and said second chamber, said first actuator, during said first stroke, arranged to actuate on said main flow of damping medium in response to a first actuating pressure in the first actuator chamber; a pilot valve arranged to control the first actuating pressure, the pilot valve having a pilot chamber in fluid communication with the first actuator chamber; a first restriction arrangement for restricting a flow of damping medium from the first actuator chamber to the pilot chamber, said first restriction arrangement arranged to provide a first flow path restricted by a first flow restriction area during a first stroke and to provide a second flow path restricted by a second flow restriction area during the second stroke; and a first sub valve arrangement comprising a first valve member, said first valve member being in a first end position during the first stroke and being in a second end position during the second stroke, wherein said first valve member is arranged to co-operate with said first restriction arrangement such that the flow of damping medium from the first actuator chamber to the pilot chamber flows via said first flow path when said first valve member is in the first end position and flows via said second flow path when said first valve member is in the second end position.

In a preferred embodiment, said pilot valve is arranged to control at least the first actuating pressure, i.e. the pilot valve is able to control two actuators. In that case, preferably the pilot chamber of the pilot valve is in fluid communication with both actuator chambers. Moreover, the pilot chamber also communicates with the first chamber and second chamber, i.e. during the first stroke the pilot chamber is in fluid communication with the second chamber and during the second stroke the pilot chamber is in fluid communication with the first chamber

When said first valve member is in the first end position during the first stroke, the first valve member closes the fluid communication between the first actuator chamber and the second chamber, i.e. the first actuator chamber is not in fluid communication with said second chamber. However, in this configuration, the first actuator chamber is in fluid communication with said first chamber. Furthermore, when said first valve member is in the second end position, the first valve member opens the fluid communication between the first actuator chamber and the second chamber, i.e. the first actuator chamber is in fluid communication with said second chamber. However, in this configuration, the first actuator chamber is not in fluid communication with said first chamber.

As envisaged by the skilled person, the shock absorber is provided with a piston which divides the shock absorber chamber into a first chamber and a second chamber. Furthermore, the piston reciprocally moves within the shock absorber chamber. During a first stroke, the piston moves towards the first chamber and pressurizes the damping medium therein which thereafter flows to the second chamber via the valve arrangement. Thus, the piston moves in one direction, whereas the damping medium flows in the opposite direction.

Thus, certain embodiments are based on the insight that by using a flow restriction arrangement and a valve arrangement having a valve member which is movable between a first end position and a second end position, different flow restrictions on the flow of damping medium from the actuator chamber to the pilot chamber may be obtained. The flow restriction arrangement is provided with at least two flow restrictions having different flow restriction areas. These different flow restrictions with different restriction areas are arranged, with regard to relative position, such that at least two flow paths with different restrictions are obtained in order to provide different flow restrictions on the flow from the actuator chamber to the pilot chamber which are dependent on the stroke, i.e. the first stroke or second stroke. In other words, the different flow restrictions have different purposes. During a first stroke, the flow from the actuator chamber to the pilot chamber is restricted by a first flow restriction in order to achieve a first restriction effect. Furthermore, during a second stroke, the flow from the actuator chamber to the pilot chamber is restricted by a second flow restriction in order to achieve a second restriction effect.

As mentioned above, the valve member is arranged to be movable between two end positions. Thus, the valve member is arranged to co-operate with the restriction arrangement to obtain different flow restrictions depending on the end position of the valve member, that is, either the first or second end position. In other words, when the valve member is at the first end position, flow from the actuator chamber to the pilot chamber is forced through a first flow path having a predetermined flow restriction, whereas when the valve member is at the second end position, flow from the actuator chamber to the pilot chamber is forced through a second flow path having a second restriction.

Since it is possible to separate the flow restriction of the flow from the actuator chamber to the pilot chamber depending on the stroke, it is thereby possible to adapt the flow restriction of the flow path to different needs during the first stroke and the second stroke. Thus, if a plunger arrangement or an annular actuator, another element or actuating member of the actuator or any other part or portion of the actuator, such as a valve member or the like, is subjected to an oscillating force or any force which could generate an oscillation or any type of movement which could have a detrimental impact on the damping characteristic and this oscillating force and/or any other type of movement would generate an oscillation of the damping medium in the actuator chamber, this movement could be attenuated by adapting the restriction of the flow path from the actuator chamber to the pilot chamber during, for example, the first stroke. Thereby, the flow path is provided with a first flow restriction area suitable for effectively attenuating any unwanted movement of damping medium in the actuator chamber. However, during the second stroke, the damping medium enters the actuator chamber, for example, from the second chamber and continues to the pilot chamber. This flow from the actuator chamber to the pilot chamber during this second stroke requires a second flow restriction area. Thus, one advantage is that certain embodiments provide at least a first and a second flow path from the actuator chamber to the pilot chamber which are arranged with at least a first and a second flow restriction during different strokes.

As is understood by the skilled person in the art, the degree of restriction which is required to attenuate any unwanted movement of damping medium in the actuator chamber is determined by the actuator volume, i.e. the volume of damping medium which is accommodated by the actuator chamber.

Furthermore, the terms “first stroke” and “second stroke” as used herein are intended to refer to either one of a compression stroke and a rebound stroke. Thus, the first stroke could be one of the compression stroke and the rebound stroke. Similarly, the second stroke could be one of the compression stroke or the rebound stroke. However, as envisaged by the skilled person in the art, if the first stroke is the compression stroke then the second stroke is the rebound stroke and vice versa, i.e. the first stroke is a stroke in a first direction whereas the second stroke is a stroke in a second direction opposite to the first direction.

According to an embodiment of the present invention the first valve member is arranged to co-operate with a channel or channel portion of said first restriction arrangement.

According to an embodiment of the present invention, the first flow path is a first channel and a second channel between the first actuator chamber and the pilot volume, and said second flow path is a second channel between the first actuator chamber and the pilot chamber, wherein said first channel and the second channel are arranged in parallel between the first actuator chamber and the pilot chamber, and wherein said first valve member is arranged to block the first channel when said first valve member is in the second end position and to unblock the first channel when said first valve member is in the first end position.

According to another embodiment of the present invention, the first valve member is movable between two channel openings defining the first and second end positions,

According to yet another embodiment of the present invention, the first valve member is a ball or a rounded element able to block the channel opening or the channel.

In a further embodiment of the present invention, the first flow restriction area is defined by a first channel portion and said second flow restriction area is defined by a second channel portion, wherein the first channel portion and the second channel portion are arranged in series between the first actuator chamber and the pilot chamber; and wherein said first valve member is arranged to bypass the second channel portion when said first valve member is in the first end position and to force the flow of damping medium from the first actuator chamber to the pilot chamber via the second channel portion when said first valve member is in the second end position.

According to an embodiment of the invention, the first valve member comprises a flexible portion forming a channel wall portion movable between the first and the second end positions thereby varying a flow restriction area.

According to another embodiment of the invention, the first valve member is a shim or a plate-shaped element

In yet another embodiment of the present invention, the first sub valve arrangement is a first shuttle valve, wherein said first valve member abuts a first seat in its first end position, and wherein the first valve member abuts a second seat in its second end position.

In an embodiment of the present invention, said first flow restriction area is greater than the second flow restriction area.

In another embodiment of the present invention, the first actuator comprises two or more plungers being arranged to actuate on the main flow of damping medium in response to the first actuating pressure.

The ring shaped actuators used in the known art are characterized by high friction especially in the case where soft seals have been specified. If seals that are not soft are used, the machined parts need to have an extreme precision to avoid too much leakage. This high level precision is very expensive and can also cause problems with friction and stick slip. In some cases, the known art uses actuators built up by a flexible shim element or similar. These kinds of actuators will solve the problem with friction and stick slip but will on the other hand cause a huge problem with undefined pressure areas which establishes the actuator force. This in turn has the disadvantage of generating big scatter on the valve output pressure.

The advantage of using two or more plungers which are arranged to actuate on the main flow of damping medium in response to the first actuating pressure is that each plunger is able to have perfect conditions in its respective hole and will thereby give the valve member a tilting capability. Furthermore, the present design will have low controlled pressure scatter, low friction, low stick slip levels and low leakage as compared with some of the known art designs. The number of plungers, their diameters, the number of combined spring rates and preloads combined with the tilting capability and asymmetry will create numerous possibilities to adapt valve characteristics within the complete pressure range to more flexibly meet customer demands with lower cost with minorly different valve types as compared to some of the known art. It is a common rule to set the lowest possible guide length for a plunger, poppet or a spool at least equal to the diameter which for some known art would generate very long actuators if they would not be exposed to stick slip which means that each actuator of the present design is 6 times shorter for a single acting valve and twelve times shorter for a double acting valve.

According to yet another embodiment of the invention, the second actuator comprises an annular actuator being arranged to actuate on the main flow of damping medium in response to the second actuating pressure.

In yet another embodiment of the present invention, the first actuator comprises an annular or ring-shaped actuator body being arranged to actuate on the main flow of damping medium in response to the first actuating pressure. The ring-shaped actuator body may be guided on an inner periphery thereof by for example the actuator housing. The ring-shaped actuator body may be used together with a plate spring or a shim stack adapted to exert an opposing spring force on a main valve member via the ring-shaped actuator body. The plate spring or shim stack may be arranged to provide a sealing function around an outer periphery of the actuator body. Thereby, a relatively large play may be used around said outer periphery. In such a manner, a relatively low friction and stick slip may be achieved. The plate spring may allow the ring-shaped actuator to always be in contact with the main valve member. Unlike the embodiments where the first actuator comprises two or more plungers, using a ring-shaped actuator body may omit the need of a force transmitting ring between the first actuator and the main valve member.

In yet another embodiment of the present invention, said valve arrangement further comprises a first valve disk being interposed between the first actuator and a first seat part, wherein the first valve disk is arranged to open and close for the main flow of damping medium from the first chamber to the second chamber against the seat part.

In a further embodiment of the present invention, said valve arrangement further comprises a second actuator having a second actuator chamber communicating with said first chamber and said second chamber, said second actuator, during said second stroke, being arranged to actuate on said main flow of damping medium in response to a second actuating pressure in the second actuator chamber; a second restriction arrangement for restricting a flow of damping medium from the first actuator chamber to the pilot chamber, said restriction arrangement being arranged to provide a third flow path restricted by a third flow restriction area during a first stroke and to provide a fourth flow path restricted by a fourth flow restriction area during the second stroke; and a second sub valve arrangement comprising a second valve member, said second valve member being in a first end position during the second stroke and being in a second end position during the first stroke, wherein said second valve member is arranged to co-operate with said second restriction arrangement such that the flow of damping medium from the second actuator chamber to the pilot chamber flows via said third flow path when said second valve member is in the first end position and flows via said fourth flow path when said second valve member is in the second end position; and wherein said pilot valve is arranged to control the first actuating pressure and the second actuating pressure, and wherein said pilot chamber is in fluid communication with the first actuator chamber and the second actuator chamber.

In another embodiment of the present invention, the second valve member is arranged to co-operate with a channel or channel portion of said second restriction arrangement.

In another embodiment of the present invention, said third flow path is a first channel between the second actuator chamber and the pilot chamber, and said fourth flow path is a second channel between the second actuator chamber and the pilot chamber, wherein said first channel and the second channel are arranged in parallel, and wherein said second valve member is arranged to block the first channel when said second valve member is in the second end position, and to unblock the first channel when said second valve member is in the first end position. In other words, the third flow path is a third channel between the second actuator chamber and the pilot chamber, and said fourth flow path is a fourth channel between the second actuator chamber and the pilot chamber, wherein said third channel and the fourth channel are arranged in parallel, and said second valve member is arranged to block the third channel when said second valve member is in the second end position. In yet another embodiment of the present invention, the second valve member is movable between two channel openings defining the first and second end positions.

In yet another embodiment of the present invention, the second valve member is a ball or a rounded element able to block the channel opening or the channel.

In a further embodiment of the present invention, the third flow restriction area is defined by a first channel portion and said fourth flow restriction area is defined by a second channel portion, wherein the first channel portion and second channel portion are arranged in series between the second actuator chamber and the pilot chamber; and wherein said second valve member is arranged to bypass the second channel when said second valve member is in the first end position and to force the flow of damping medium from the second actuator chamber to the pilot chamber via the second channel when said second valve member is in the second end position. In other words, the third flow restriction area is defined by a third channel portion and said fourth flow restriction area is defined by a fourth channel portion, wherein the third channel portion and fourth channel portion are arranged in series between the second actuator chamber and the pilot chamber; and the second valve member is arranged to bypass the fourth channel when said second valve member is in the first end position and to force the flow of damping medium from the second actuator chamber to the pilot chamber via the fourth channel when said second valve member is in the second end position.

In another embodiment of the present invention, the first valve member comprises a flexible portion forming a channel wall portion movable between the first and the second end positions thereby varying a flow restriction area.

In another embodiment of the present invention, the first valve member is a shim or a plate-shaped element.

In yet another embodiment of the present invention, the second sub valve arrangement is a second shuttle valve, wherein said second valve member abuts a third seat in its first end position, and wherein the second valve member abuts a fourth seat in its second end position.

According to another embodiment of the present invention, said third flow restriction area is greater than the fourth flow restriction area.

In an embodiment of the present invention, the second actuator comprises two or more plungers being arranged to actuate on the main flow of damping medium in response to the second actuating pressure.

In yet another embodiment of the present invention, said valve arrangement further comprises a second valve disk being interposed between the second actuator and a second seat part, wherein the second valve disk is arranged to open and close for the main flow of damping medium from the second chamber to the first chamber against the seat part.

According to another embodiment of the present invention, the second actuator comprises an annular actuator being arranged to actuate on the main flow of damping medium in response to the second actuating pressure.

In yet another embodiment of the present invention, the second actuator comprises an annular or ring-shaped actuator body being arranged to actuate on the main flow of damping medium in response to the second actuating pressure. The ring-shaped actuator body may be guided on an inner periphery thereof by for example the actuator housing. The ring-shaped actuator body may be used together with a plate spring or a shim stack adapted to exert an opposing spring force on a main valve member via the ring-shaped actuator body. The plate spring or shim stack may be arranged to provide a sealing function around an outer periphery of the actuator body. Thereby, a relatively large play may be used around said outer periphery. In such a manner, a relatively low friction and stick slip may be achieved. The plate spring may allow the ring-shaped actuator to always be in contact with the main valve member. Unlike the embodiments where the second actuator comprises two or more plungers, using a ring-shaped actuator body may omit the need of a force transmitting ring is between the second actuator and main valve member.

In a further embodiment of the present invention, the first stroke is one of a compression stroke and a rebound stroke of the shock absorber, and the second stroke is the other of the compression stroke and the rebound stroke.

In a further embodiment of the present invention, said two or more plungers are arranged to exert a actuator force on said valve disk in response to a pilot pressure (pp), wherein said actuator force may be varied by varying at least one the following:

a diameter size or of the plungers plunger, and

the number of plungers, thereby friction, stick slip and leakage can be held within acceptable levels.

In a further embodiment of the present invention, said two or more plungers are arranged to be, relative to each other, individually movable in order to generate an actuator force to tilt said valve disk such that a tilting movement of the valve disc may be achieved such that friction and stick slip can be held within low levels.

In a further embodiment of the present invention, said first and/or second actuator further comprises springs which are arranged with different preload and spring rates in order to provide a spring force action such that the valve member is controllable in a plurality of ways to obtain a plurality of different tilting patterns which will increase the freedom of selectable valve characteristics at low or zero pilot pressures.

In a further embodiment of the present invention, the valve arrangement is provided with a piston rod including a solenoid, a pilot valve with controllable pilot pressure pp and a piston dividing a shock absorber into a first and a second chamber. The valve arrangement further comprises at least one disk or a shims arrangement which are actuated on by at least one actuator. Alternatively, the valve arrangement may be provided with two actuators arranged on either side of the piston.

The actuator is provided by a plurality of plungers, minimum of 2 up to 13, which are arranged in a circle around the valve centre and guided in a plunger housing. The plungers are affected by a pilot pressure pp in such a way that the pressure force on each plunger generates an added actuator force Fp which can span widely depending on the selected plunger diameter sizes and numbers of plungers. Thereby, the friction, stick slip and leakage can be held within low levels.

Alternatively, the plungers can move individually in such a way that the valve member can move freely for example with a tilting movement so that the friction and stick slip can be held within low levels. In another alternative, the plungers can be equipped and affected by springs with different preload and spring rates which make the spring force action control the valve member in a plurality of ways, giving the valve a plurality of different tilting patterns which will increase the freedom of selectable valve characteristics at low or zero pilot pressures.

### BRIEF DESCRIPTION OF THE DRAWINGS

Further details and aspect of the present invention will become apparent from the following detailed description with reference to accompanying drawings, in which:

FIG. 1 is a schematic illustration of a known variant of simple pressure regulator,

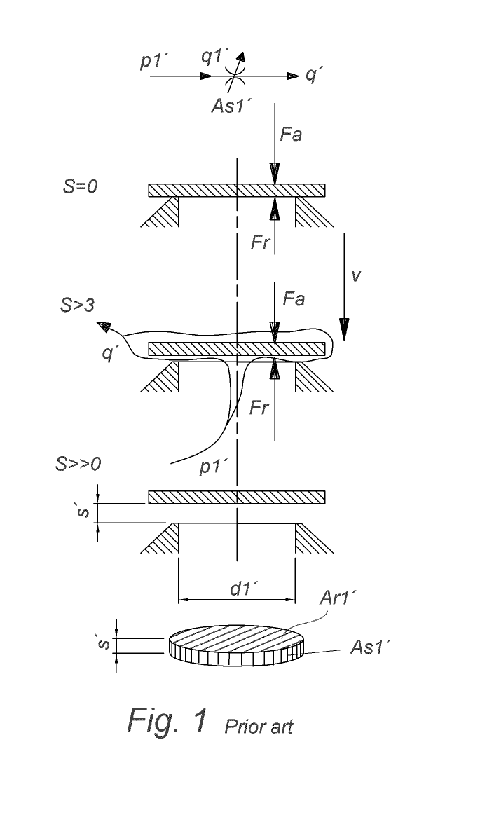

FIG. 2 is a cross-sectional schematic view of a dual-action and pilot controlled shock absorber valve according to an embodiment of the present invention,

FIG. 3a-b are cross-sectional schematic views of an alternative embodiment of the present invention,

FIG. 4a-d are schematic diagrams of a dual-action and pilot controlled shock absorber valve according to an embodiment of the present invention,

FIG. 4e-f are schematic diagrams of known dual-action and pilot controlled shock absorber valve,

FIG. 5a-b are cross-sectional schematic views of another alternative embodiment of the present invention,

FIG. 6a-b are cross-sectional schematic views of yet another alternative embodiment of the present invention.

### DETAILED DESCRIPTION OF THE PREFERRED EMBODIMENT

The present invention will now further be described in connection with the accompanying drawings. It should be noted that even though a valve arrangement with an electronically controlled pilot valve will be described and illustrated, the present invention is also applicable to valve arrangements with pilot valves that are not electronically controlled. Furthermore, it should also be noted that even though a dual-action valve arrangement will be described and illustrated, the present invention is also applicable to valve arrangements arranged to only act with one of the compression stroke and rebound stroke.

An electronically controlled pilot valve is controlled by a control device having processing capabilities via a control signal from the control device. The control device takes into account vehicle parameters, such as the speed of the vehicle and angle of the steering element. These parameters affect the control signal which, in turn affects the parameter of the pilot valve and the damping characteristics of the shock absorber.

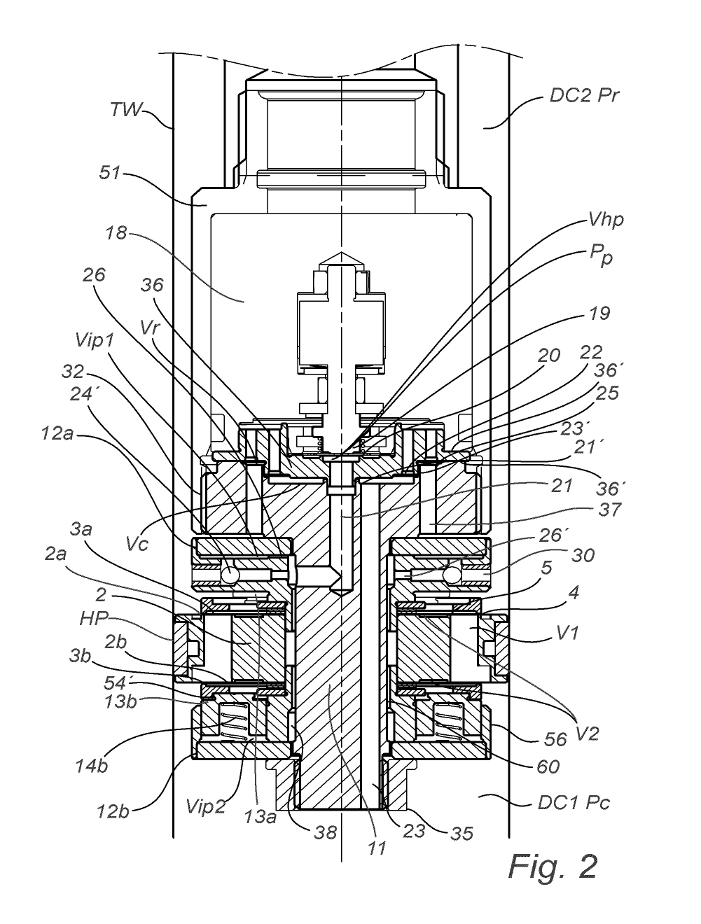

With reference to FIG. 2, a dual-action valve arrangement in a pilot controlled shock absorber is shown. A main piston 2 partitions the damping cylinder of the shock absorber into a second chamber DC1 Pc and a first chamber DC2 Pr. In this case, the second chamber DC1 Pc is the compression chamber and the first chamber DC2 Pr is the rebound chamber. The main piston 2 is secured to a piston rod. The movement of the main piston 2 in the tube wall TW of the damping cylinder creates a flow of damping medium between the respective damping chambers via a shock absorber valve, i.e. a valve arrangement, which is integrated with the piston 2.

In the embodiment shown in FIG. 2, the shock absorber valve is arranged in the main piston. However, it is understood that the shock absorber valve may be arranged in a separate space interconnected with the damping chambers DC1 Pc and DC2 Pr. The hydraulic damping medium provided in the damping cylinder is pressurized with a gas pressure Pg to reduce the risk of cavitation in the damping medium, i.e. a high cavitation pressure.

In FIG. 2, the pressure regulator has plurality of seat parts on either side of the main piston 2, wherein the seat part is a portion of the main piston 2. On either side of the main piston 2, a first main valve member 3b and a second main valve member 3a is provided. The first main valve member 3b and the second main valve member 3a is arranged to co-operate with the plurality of seat parts in order to obtain a valve function. In other words, the main valve members 3a and 3b interact with the seat parts to obtain a valve function.

Furthermore, on either side of the piston 2, a plurality of plungers 13a and 13b is arranged, which exerts an opposing force against the main valve members 3a and 3b. In other words, the plungers or actuators are arranged to exert an actuating force on the main valve members 3a and 3b. The plunger is hollow to allow a spring 14a, 14b therein. In other words, the plunger has an inner surface which defines a compartment in which a spring is arranged. Also, together with a plurality of wall portions of the shock absorber valve, the inner surface of the plunger defines an actuating volume arranged to be filled with damping medium which is in fluid communication with a pilot volume of the pilot valve.

Thus, the inner surface of the plurality of plungers are subjected to a pilot pressure force Fp, i.e. the actuating force, on the first main valve member 3a and the second main valve member 3b. The pilot pressure force is generated by the pressurized damping medium within the actuating volume which acts on the inner surface of the plunger. The pressurized damping medium is pressurized to a pilot pressure. As mentioned above, each of the plurality of plungers 13a, 13b also provide support for at least one spring 14b, which, via the plunger body, exerts an opposing spring force Ff on the main valve members 3a and 3b. Thus, the inner surface of the plurality of plungers is subjected to a total opposing force Fa that includes flow forces, other spring forces from for example deflected shim valve members, frictions forces consisting of the pilot pressure force Fp and the spring force Ff. This total opposing force is exerted on the main valve members 3a and 3b and is balanced by a counteracting a regulating force Fr that is created by the flow of damping medium through the seat part, operating as described above.

The working range for the pressure regulator, i.e. the difference between highest and lowest pressure, is determined by the diameter and the number of plungers 13a, 13b which can be used for the particular application. The shape of the part of the plungers 13a, 13b facing the main valve member is significant for how the opening movement of the main valve member 3 occurs in relation to the seat part.

The number of plungers 13a, 13b can also be different at the compression side and the rebound side of the seat part in order to provide an individual action characteristic depending on the compression stroke and the rebound stroke. In other words, the pressure level during the rebound stroke R is greater than during the compression stroke C, or vice versa depending on the application. In addition, the plungers may be arranged asymmetrically to create both highest and lowest pressure levels and corresponding characteristics depending on the application. Furthermore, the springs 14a, 14b inside symmetrically placed plungers 13a, 13b can also be arranged asymmetrically in terms of preload and spring constant. Each of the springs 14a, 14b can thus have a different preload and spring constant. The number of plungers and their diameters can also be varied in order to adapt the size of the pressure level/working region.

There is not a significant pressure drop across the inlet to shuttle valve when fluid passes into the pilot system. Thus, the pressure on the inside of the plungers Vip1 or Vip2, i.e. the pressure in the actuator chamber, and the pressure on the outside of the plungers, i.e. the pressure in the chamber DC1 Pc or DC 2 Pr, are essentially the same. Since the plunger on the inactive side is not subjected to any significant damping medium forces, i.e. resulting forces due to pressurized damping medium, the spring force ensures the plungers always to be in contact with their respective main valve member, which is one reason for including such springs at that location.

Furthermore, instead of making the actuator ring shaped as in the referred known art, the actuator in hand is built up by two or more plungers 13 which are well fitted in the plunger housing 56 in order to be able to slide with low leakage and friction. The plungers preferably have the same diameter and are equally distributed around a suitable diameter, the added surface Ap of each plunger meeting the fluid inside the circular chambers Vip. Multiplying the pilot pressure pp with the area Ap produces the pilot pressure force Fp which is the current controlled part of the added forces Fa biasing the regulator force Fr. Each plunger acts with its distributed force directly on a disc shaped main valve member 3 or indirectly on a shim package 3′ via a force transmitting ring 54′. The plungers can move individually which permits the disc/shim package/ring, i.e. the main valve member, to move at an angle or parallel to the seat without causing an increase in the friction forces. This is an advantage because low hysteresis and stick slip can be maintained. The plungers can be permitted to have different diameters and/or be unevenly distributed in order to control the movement in different tilting patterns which will increase the freedom of selectable valve characteristics. Preferably inside each plunger there is a spring 14 making the plunger always be in contact with the main valve member 3 or the ring 54. When the main valve member 3 is a shim package, the spring force includes the bending in the spring package itself. There is not a significant pressure drop across the inlet to shuttle valve when fluid passes into the pilot system, which means that the plungers inside the chambers Vip are subjected to the same pressure on both their circular inner and outer sides. This ensures that the plungers are always in contact with their respective main valve member, which is one of the reasons for including the springs. The force transmitting ring 54 which preferably is guided by the plungers on the shoulder 54′ distributes the pilot pressure forces on the shim package because the force transmitting ring 54 is by nature too weak to handle the force from each plunger without harmful deflection. Since each spring inside the plungers is applying force to its respective plunger, different combinations of preloads and spring rates are possible for each plunger which in turn can create the opportunity to have different tilting patterns which will increase the freedom of selectable valve characteristics at low or zero pilot pressures as well.

FIG. 2 shows a valve arrangement for controlling a main flow of damping medium in a shock absorber from a first chamber DC2 Pr, in this case a rebound chamber, to a second chamber DC1 Pc, in this case a compression chamber, during a first stroke and from the second chamber to the first chamber during a second stroke. A first actuator has a first actuator chamber Vip2 which communicates with the first chamber DC2 Pr and the second chamber DC1 Pc. The first actuator, during the first stroke, actuates on the main flow of damping medium in response to a first actuating pressure in the first actuator chamber Vip2. A pilot valve is arranged to control the first actuating pressure. The pilot valve has a pilot chamber 21 which is in fluid communication with the first actuator chamber. A first restriction arrangement for restricting a flow of damping medium from the first actuator chamber to the pilot chamber is shown. The first restriction arrangement is arranged to provide a first flow path which is restricted by a first flow restriction area during a first stroke. Thus, the first flow path is has a first flow restriction area. The first restriction arrangement provides a second flow path restricted by a second flow restriction area during the second stroke. Thus, the second flow path has a second flow restriction area.

The first restriction arrangement further comprises a first sub valve arrangement comprising a first valve member (not shown but corresponds to the second valve member 24′ in the second restriction arrangement, i.e. the upper restriction arrangement), wherein said first valve member is in a first end position during the first stroke. Thus, the first actuator chamber Vip2 is not in fluid communication with the second chamber DC1 Pc.

The first valve member cooperates with the first restriction arrangement such that the flow of damping medium from the first actuator chamber Vip2 to the pilot chamber 21 flows via the first flow path when the first valve member is in the first end position. The first valve member cooperates with the first restriction arrangement by unblocking the first channel (not shown but corresponds to the third channel, denoted 26′, in the second restriction arrangement, i.e. the upper restriction arrangement) when the first valve member is in the first end position, i.e. during the first stroke. This allows damping medium to flow in parallel between the first actuator chamber Vip2 and the pilot chamber 21 via the first channel and the second channel (not shown but corresponds to the fourth channel, denoted 26, in the second restriction arrangement, i.e. the upper restriction arrangement). The first flow path thus is formed by the first channel and the second channel in parallel. Because the flow restriction area of the first channel is substantially larger or greater than the flow restriction area of the second channel, the flow through the first channel will dominate, i.e. the flow through the second channel will be negligible in comparison with the flow through the first channel. The first flow restriction area can thus be approximated by the flow restriction area of the first channel. In other words, the flow of damping medium from the first actuator chamber to the pilot chamber flows via said first flow path. Furthermore, the first valve member blocks a flow passage (not shown, but corresponds to the flow passage denoted 30 in the second restriction arrangement) between the second chamber DC1 Pc and the first actuator chamber Vip2 when the first valve member is in the first end position.

The first valve member is further arranged to cooperate with the first restriction arrangement such that the flow of damping medium from the first actuator chamber Vip2 to the pilot chamber 21 flows via the second flow path when the first valve member is in the second end position. When the first valve member is in the second end position, i.e. during the second stroke, the first valve member blocks the first channel, thereby allowing a flow of damping medium to flow between the first actuator chamber Vip2 and the pilot chamber 21 via the second channel only. Because the flow restriction area of the second channel is substantially smaller than the flow restriction area of the first channel, the flow is more strongly restricted compared to when the first valve member is in the first end position. The second flow path thus comprises or is formed by the second channel. The second flow restriction area is thus equal to the flow restriction area of the second channel. Furthermore, the first valve member unblocks the flow passage between the second chamber DC1 Pc and the first actuator chamber Vip2 when it is in the second end position.

Moreover, a second actuator, the upper actuator, having a second actuator chamber is shown which is able to communicate with the first chamber DC2 Pr and the second chamber DC1 Pc. Furthermore, the second actuator, during the second stroke, is arranged to actuate on the main flow of damping medium in response to a second actuating pressure in the second actuator chamber. FIG. 2 further shows a second restriction arrangement for restricting a flow of damping medium from the first actuator chamber to the pilot chamber, wherein the restriction arrangement is arranged to provide a third flow path restricted by a third flow restriction area during a first stroke and to provide a fourth flow path restricted by a fourth flow restriction area during the second stroke. Furthermore, a second sub valve arrangement is shown which comprises a second valve member 24′, wherein the second valve member 24′ is in a second end position during the first stroke. The second valve member 24′ is in a first end position during the second stroke. Due to the pressure in the first chamber DC2 Pr, the second valve member 24′ is forced into its first end position. Oppositely, during a second stroke the second valve member 24′ is forced into its second end position due to the pressure in the second chamber DC1 Pc. In FIG. 2 the valve member is ball shaped, i.e. the valve member is a ball body. The second valve member 24′ is arranged to cooperate with the second restriction arrangement such that the flow of damping medium from the second actuator chamber Vip1 to the pilot chamber 21 flows via the third flow path when the second valve member is in the first end position. The second valve member 24′ cooperates with the second restriction arrangement by unblocking the third channel 26′ when the second valve member 24′ is in the first end position, i.e. during the second stroke, thereby allowing a flow of damping medium to flow between the second actuator chamber Vip1 and the pilot chamber 21 via the third channel 26′ and the fourth channel 26 in parallel. Because the flow restriction area of the third channel is substantially larger than the flow restriction area of the fourth channel, the flow through the third channel will dominate, i.e. the flow through the fourth channel will be negligible in comparison with the flow through the third channel. The third flow path thus comprises or is formed by the third channel 26′ and the fourth channel 26 in parallel. The third flow restriction area can thus be approximated by the flow restriction area of the third channel 26′. In other words, the flow of damping medium from the second actuator chamber Vip1 to the pilot chamber 21 flows via the third flow path. Furthermore, the second valve member 24′ blocks a flow passage 30 between the first chamber DC2 Pr and the second actuator chamber Vip1 when it is in the first end position.

The second valve member 24′ is further arranged to cooperate with the second restriction arrangement such that the flow of damping medium from the second actuator chamber Vip1 to the pilot chamber 21 flows via the fourth flow path when the second valve member is in the second end position. In FIG. 2 the second valve member is in the second end position. The second valve member cooperates with the second restriction arrangement by blocking the third channel 26′ when the second valve member is in the second end position, i.e. during the first stroke, thereby allowing a flow of damping medium to flow between the second actuator chamber Vip1 and the pilot chamber 21 via the fourth channel 26 only. Because the flow restriction area of the fourth channel 26 is substantially smaller than the flow restriction area of the third channel 26′, the flow is more strongly restricted compared to when the second valve member is in the first end position. The fourth flow path thus comprises or is formed by the fourth channel 26. The fourth flow restriction area is thus equal to the flow restriction area of the fourth channel 26. Furthermore, the second valve member unblocks the flow passage 30 between the first chamber DC2 Pr and the second actuator chamber Vip1 when it is in the second end position.

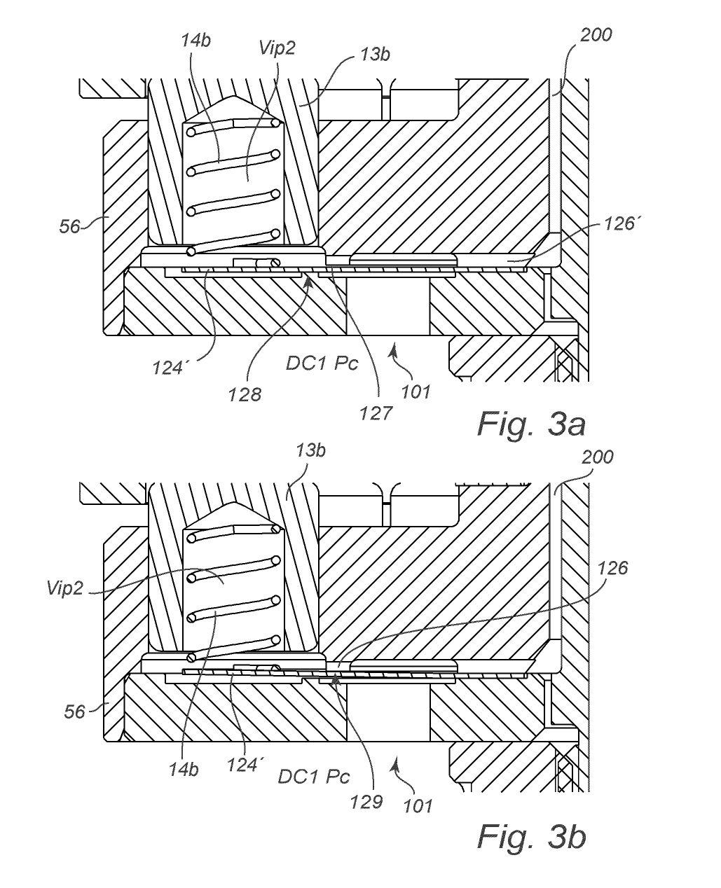

In FIGS. 3a and 3b, cross-sectional schematic views of an alternative embodiment of the present invention are shown. The plunger 13b is arranged in the plunger housing 56. Inside the hollow of the plunger the spring 14b is arranged which is adapted to exert an opposing spring force Ff on the valve member 3b (not shown) via the plunger body. The inner surface of the hollow part of the plunger 13b together with an inner surface of the plunger housing 56 defines a plunger chamber. The plunger chamber together with the other plunger chambers on either side of the piston forms part of the actuator chamber. Thus, the plunger chambers of the first actuator form a part of the first actuator chamber and the plunger chambers of the second actuator form a part of the second actuator chamber. A first channel portion 126′ and a second channel portion 126 are arranged in series such that a flow from the first actuator chamber to the pilot chamber first flows through the second channel portion 126 and thereafter through the first channel portion 126′. Thus, the flow of damping medium flows from the first actuator chamber via the first channel portion 126′ and the second channel portion to a pilot chamber portion 200 which is in fluid communication with the pilot chamber. However, as will be described below, during the first stroke the second channel portion 126 is bypassed such that the flow is unrestricted when it passes the second channel portion 126, i.e. the flow unrestrictedly passes the second channel. The second channel portion 126 comprises at least one groove, slot or slit in the second seat 129. When the first valve member 124′ is in the first end position, as show in FIG. 3a, the first valve member is not in abutment with the second seat 129, and the groove, slot or slit in the second seat is open, i.e. not enclosed by the first valve member, towards the bypassing channel portion 127. When the first valve member 124′ is in the second end position however, as show in FIG. 3b, the first valve member is in abutment with the second seat, thereby forming a wall of the second channel portion 126, i.e. the first valve member closes or encloses the groove, slot or slit in the second seat 129, such that the flow from the first actuator chamber to the pilot chamber is forced through the second channel portion 126. When the first valve member 124′ is in the first end position, the bypassing channel portion 127 is formed or defined between the second seat 129 (including the groove, slot or slit) and the first valve member 124′. It is understood that the bypassing channel portion is annular, i.e. it is formed or defined around the circumference of the second seat 129. Therefore, the flow restriction area of the bypassing portion is substantially larger than that of the second channel portion 126, such that flow bypasses the second channel portion 126. It is also understood that the flow restriction area of the bypassing portion is substantially larger than that of the first channel portion 126′ such that the flow from the first actuator chamber to the pilot chamber is restricted by the first channel portion 126′ when the first valve member is in the first end position.

In FIG. 3a, a first sub valve arrangement comprising a first valve member 124′ is shown, wherein the first valve member is in a first end position. When the first valve member 124′ is in the first end position during the first stroke, the first valve member 124′ abuts a seat 128 of the first sub-valve arrangement which thereby closes the first actuator chamber against the second chamber DC1Pc. Thus, when the first valve member 124′ is in the first end position the first actuator chamber is in fluid communication with the first chamber. In this case, the first valve member 124′ cooperates with the first sub valve arrangement to provide a bypassing channel portion 127 in parallel with the second channel portion 126 such that the flow is able to pass from the first actuator chamber to the first channel portion without restricting the flow, at least in relation to the flow restriction of the first channel portion. Thus, when the first valve member 124′ is in the first end position, the first valve member 124′ together with a surface of the first restriction arrangement forms the bypassing channel portion 127. In other words, the bypassing channel portion 127 provides a substantially larger flow restriction area than the second flow restriction area of the second channel portion 126 such that the flow through the second channel portion 126 is negligible in comparison with the flow through the bypassing channel portion 127. Thereby the second channel portion 126 is effectively bypassed, i.e. the overall restriction of the flow is not limited by the second flow restriction area. The flow restriction area of the bypassing channel portion 127 is furthermore greater than the first flow restriction area of the first channel portion 126′, such that the overall restriction of the flow from the first actuator chamber Vip2 to the pilot chamber is restricted by the first channel portion 126′. Put differently, the second channel portion 126 together with the bypassing channel portion 127 constitutes a variable channel portion which, when the first valve member 124′ is in the first end position, has a flow restriction area corresponding to that of the bypassing channel portion 127. In the other case, when the first valve member 124′ is in the second end position, the variable channel has a flow area, i.e. a cross-sectional area, which equals the second flow restriction area which is restrictive in relation to the flow restriction area of the first channel portion 126′.

The first channel portion 126′ has a first flow restriction area and the second channel portion 126 has a second flow restriction area. Thus, when the first valve member 124′ is in the first end position, the flow of damping medium from the first actuator chamber to the pilot chamber is a first flow path which has a first flow restriction since the restriction of the flow is determined by the flow restriction area of the first channel portion 126′, i.e. first flow restriction area.

In FIG. 3b, the first valve member 124′ is in a second end position during the second stroke. When the first valve member 124′ is in the second end position, the first valve member 124′ abuts a second seat 129 of the first sub-valve arrangement and is released from the first seat 128 of the first sub-valve arrangement. Thereby the bypassing channel portion 127 is closed and a flow passage from the first actuator chamber to the second chamber DC1 Pc is opened between the first valve member 124′ and the first seat 128. Thus, when the first valve member 124′ is in the second end position, the first actuator chamber Vip2 is in fluid communication with the second chamber DC1 Pc. The flow of damping medium from the first actuator chamber to the pilot chamber is a second flow path which has a second flow restriction since the restriction of the flow is determined by the flow restriction area of the second channel portion 126, i.e. the second flow restriction area.

As mentioned above, when the first valve member 124′ is in the first end position, the first valve member is arranged to bypass the second channel. The flow is thus restricted by the first restriction area of the first channel portion 126′. When the first valve member 124′ is in the second end position, the flow of damping medium from the first actuator chamber is forced through the second channel portion 126 and thereafter to the pilot chamber via the first channel portion 126′.

It is understood that a corresponding arrangement as illustrated in FIGS. 3a and 3b and described above may be used in the other flow direction analogously with FIG. 2. In another embodiment, an arrangement as illustrated in FIGS. 3a and 3b and described above may be used in one flow direction, i.e. for restricting a flow from a first actuator chamber to the pilot chamber, and a fixed restriction arrangement may be used for in the other flow direction, i.e. for restricting a flow from a second actuator chamber to the pilot chamber.

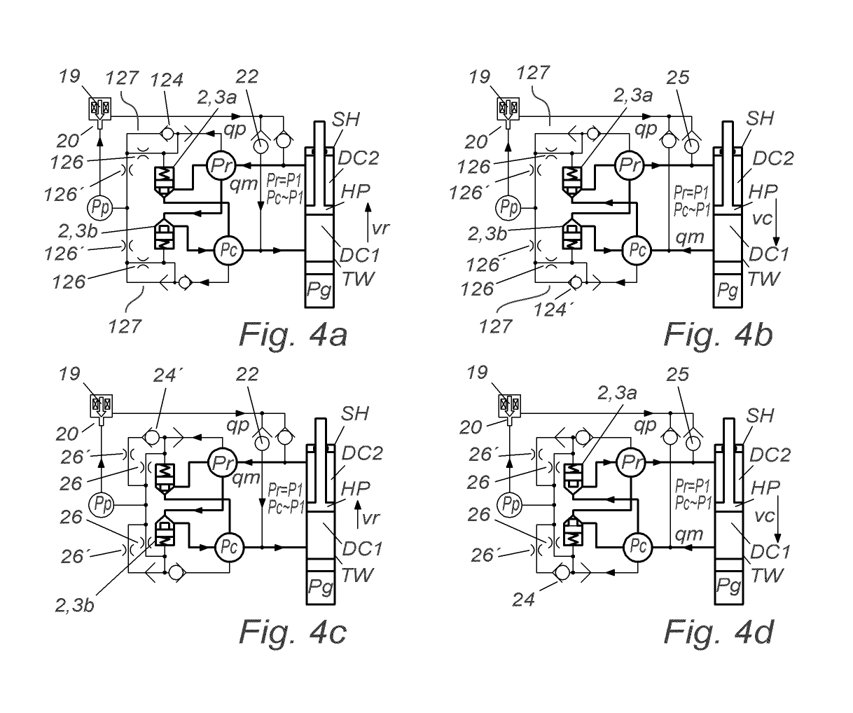

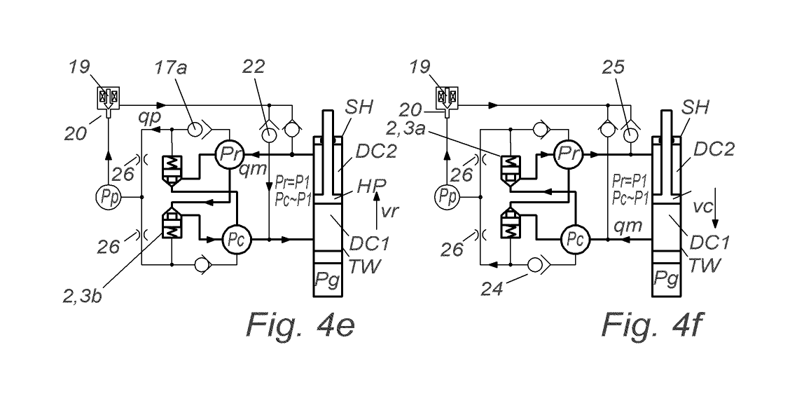

In FIG. 4a-d, schematic diagrams of a dual-action and pilot controlled shock absorber valve according to an embodiment of the present invention is shown. In FIGS. 4a and 4b, the flow restriction areas 126 and 126′ are arranged in series in accordance with the embodiment shown in FIG. 3a-b. In FIG. 4c-d the flow restriction areas 26 and 26′ are arranged in parallel in accordance with the embodiment shown in FIG. 2.

In FIG. 4e-f, schematic diagrams of known dual-action and pilot controlled shock absorber valves are shown.

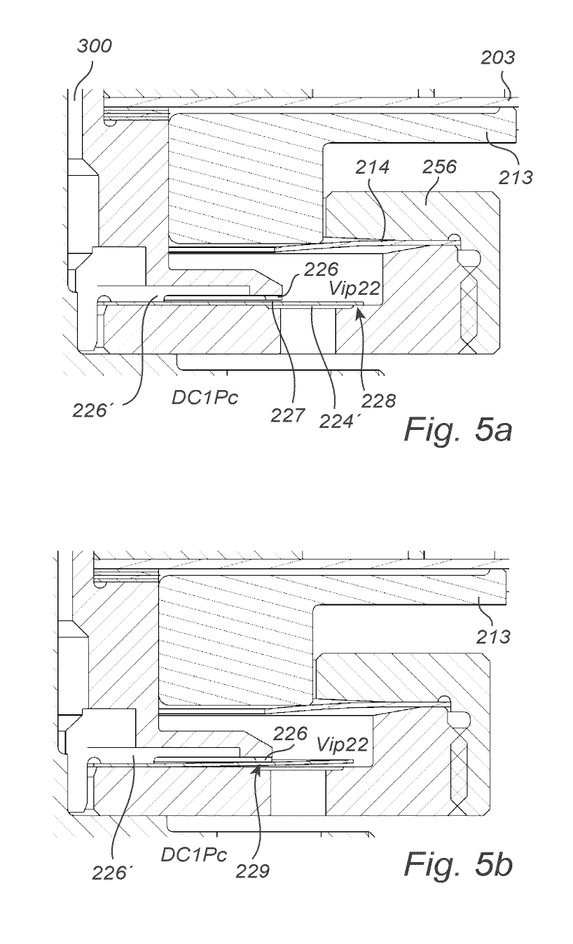

In FIGS. 5a and 5b, cross-sectional schematic views of another alternative embodiment of the present invention are shown. Instead of using plungers to actuate on the main flow of damping medium in response to a first actuating pressure (as shown in FIGS. 2 and 3a-b), a single ring-shaped actuator is used to actuate on the main flow in each direction. In FIGS. 5a and 5b, a first ring-shaped actuator 213 is shown. The ring-shaped actuator is arranged in the actuator housing 256. A plate spring 214 is attached to the actuator housing 256 along its outer circumference, and is adapted to exert an opposing spring force on the main valve member 203 via the first ring-shaped actuator 213. The plate spring 214 allows the ring-shaped actuator 213 to always be in contact with the main valve member 203. Note that unlike the embodiments shown in FIGS. 2 and 3, no force transmitting ring is used between the actuator and main valve member. The bottom surface of the first ring-shaped actuator 213 together with inner surfaces of the actuator housing 256 defines a first actuator chamber Vip22. A first channel portion 226′ and a second channel portion 226 are arranged in series such that flow from the first actuator chamber to the pilot chamber first flows through the second channel portion 226 and thereafter the first channel portion 226′. Thus, the flow of damping medium flows from the first actuator chamber via the first channel portion 226′ and the second channel portion 226 to a pilot chamber portion 300 which is in fluid communication with the pilot chamber. However, as will be described below, during the first stroke the second channel portion 226 is bypassed such that the flow is unrestricted when it passes the second channel portion 226, i.e. the flow unrestrictedly passes the second channel. The second channel portion 226 comprises at least one groove, slot or slit in the second seat 229. When the first valve member 224′ is in the first end position, as shown in 5a, the first valve member 224′ is not in abutment with the second seat 229, and the groove, slot or slit in the second seat 229 is open, i.e. not enclosed by the first valve member 224′, towards the bypassing channel portion 227. When the first valve member 224′ is in the second end position however, as show in FIG. 5b, the first valve member 224′ is in abutment with the second seat 229, thereby forming a wall of the channel portion 226, i.e. the first valve member 224′ closes or encloses the groove, slot or slit in the second seat 229, such that flow from the first actuator chamber to the pilot chamber is forced through the second channel portion 226. When the first valve member 224′ is in the first end position, the bypassing channel portion 227 is formed or defined between the second seat 229 (including the groove, slot or slit) and the first valve member 224′. It is understood that the bypassing channel portion 227 is annular, i.e. it is formed or defined around the circumference of the second seat 229. Therefore, the flow restriction area of the bypassing portion 227 is substantially larger than that of the second channel portion 226, thereby bypassing the second channel portion 226. It is also understood that the flow restriction area of the bypassing portion 227 is substantially larger than that of the first channel portion 226′ such that the flow from the first actuator chamber to the pilot chamber is restricted by the first channel portion 226′ when the first valve member 224′ is in the first end position.

In FIG. 5a, a first sub valve arrangement comprising a first valve member 224′ is shown, wherein the first valve member 224′ is in a first end position. When the first valve member 224′ is in the first end position during the first stroke, the first valve member 224′ abuts a first seat 228 of the first sub-valve arrangement which thereby closes the first actuator chamber against the second chamber DC1Pc. In this case, the first valve member 224′ cooperates with the first sub valve arrangement to provide a bypassing channel portion 227 in parallel with the second channel portion 226 such that the flow is able to pass from the first actuator chamber to the first channel portion without restricting the flow, at least in relation to the flow restriction of the first channel portion 226′. Thus, when the first valve member 224′ is in the first end position, the first valve member 224′ together with a surface of the first restriction arrangement forms the bypassing channel portion 227. The bypassing channel portion 227 provides a substantially larger flow restriction area than the second flow restriction area of the second channel portion 226 such that the flow through the second channel portion 226 is negligible in comparison with the flow through the bypassing channel portion 227. Therefore the second channel portion 226 is effectively bypassed, i.e. the overall restriction of the flow is not limited by the second flow restriction area. The flow restriction area of the bypassing channel portion 227 is furthermore greater than the first flow restriction area of the first channel portion 226′, such that the overall restriction of the flow from the first actuator chamber Vip22 to the pilot chamber is restricted by the first channel portion 226′. Put differently, the second channel portion 226 together with the bypassing channel portion 227 constitute a variable channel portion which, when the first valve member 224′ is in the first end position, has a flow restriction area corresponding to that of the bypassing channel portion 227. In the other case, when the first valve member 224′ is in the second end position, the variable channel has a flow area, i.e. a cross-sectional area, which equals the second flow restriction area which is restrictive in relation to the flow restriction area of the first channel portion 226′. The first channel portion 226′ has a first flow restriction area and the second channel portion 226 has a second flow restriction area. Thus, when the first valve member 224′ is in the first end position, the flow of damping medium from the first actuator chamber to the pilot chamber is a first flow path which has a first flow restriction since the restriction of the flow is determined by the flow restriction area of the first channel portion 226′, i.e. first flow restriction area.

In FIG. 5b, the first valve member 224′ is in a second end position. When the first valve member 224′ is in the second end position during the second stroke, the first valve member 224′ abuts a second seat 229 of the first sub-valve arrangement and is released from the first seat 228 of the first sub-valve arrangement. The bypassing channel portion 227 is closed and a flow passage from the first actuator chamber to the second chamber DC1Pc is opened between the first valve member 224′ and the first seat 228. Thus, when the first valve member 224′ is in the second end position, the first actuator chamber Vip22 is in fluid communication with the second chamber DC1Pc. The flow of damping medium between the first actuator chamber and the pilot chamber is a second flow path which has a second flow restriction since the restriction of the flow is determined by the flow restriction area of the second channel portion 226, i.e. the second flow restriction area.

As mentioned above, when the first valve member 224′ is in the first end position the first valve member 224′ is arranged to bypass the second channel portion 226. The flow is thus restricted by the first restriction area of the first channel portion 226′. When the first valve member 224′ is in the second end position, the flow of damping medium from the first actuator chamber is forced through the second channel portion 226 and thereafter to the pilot chamber via the first channel portion 226′.

It is understood that a corresponding arrangement as illustrated in FIGS. 5a and 5b and described above may be used in the other flow direction analogously with FIG. 2. In another embodiment, an arrangement as illustrated in FIGS. 5a and 5b and described above may be used in one flow direction, i.e. for restricting a flow from a first actuator chamber to the pilot chamber, and a fixed restriction arrangement may be used for in the other flow direction, i.e. for restricting a flow from a second actuator chamber to the pilot chamber.

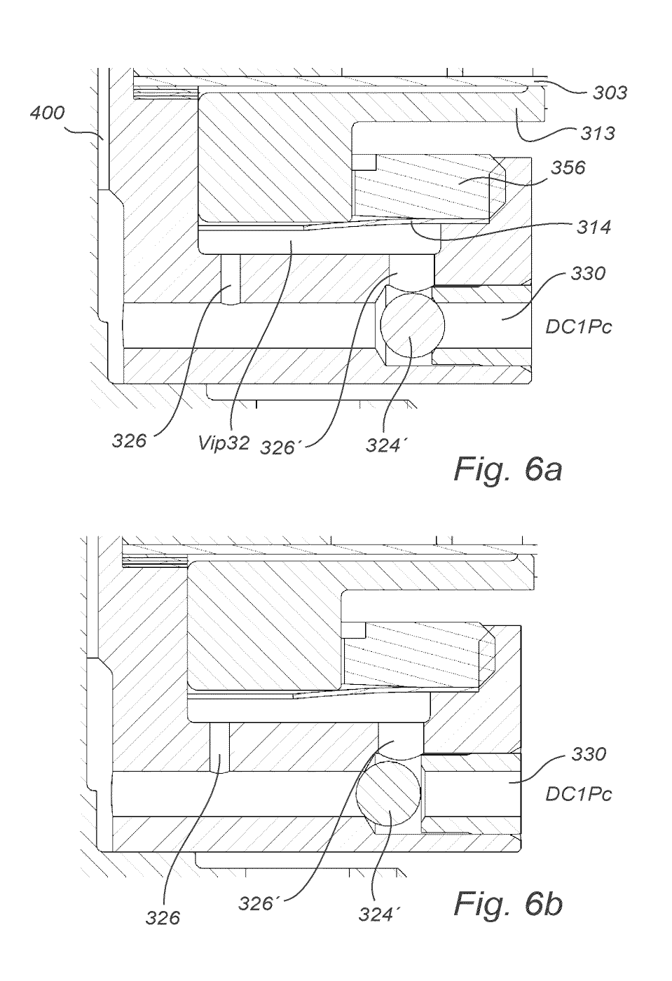

In FIGS. 6a and 6b, cross-sectional schematic views of yet another alternative embodiment of the present invention are shown. Instead of using plungers to actuate on the main flow of damping medium in response to a first actuating pressure (as shown in FIGS. 2 and 3a-b), a single ring-shaped actuator is used to actuate on the main flow in each direction. In FIGS. 2 6a and 6b, a first ring-shaped actuator 313 is shown. The ring-shaped actuator is arranged in the actuator housing 356. A plate spring 314 is attached to the actuator housing 356 along its outer circumference, and is adapted to exert an opposing spring force on the main valve member 303 via the first ring-shaped actuator 313. The plate spring 314 allows the ring-shaped actuator 313 to always be in contact with the main valve member 303. Note that unlike the embodiments shown in FIGS. 2 and 3, no force transmitting ring is used between the actuator and main valve member. The bottom surface of the first ring-shaped actuator 313 together with the inner surfaces of the actuator housing 356 defines a first actuator chamber Vip32. A first restriction arrangement is shown for restricting a flow of damping medium from the first actuator chamber to a pilot chamber 21. The first restriction arrangement is arranged to provide a first flow path which is restricted by a first flow restriction area during a first stroke. Thus, the first flow path is provided with the first flow restriction area. The first restriction arrangement is further arranged to provide a second flow path restricted by a second flow restriction area during the second stroke. Thus, the second flow path is provided with the second flow restriction area. The first restriction arrangement further comprises a first sub valve arrangement comprising a first valve member 324′, wherein the first valve member is in a first end position during the first stroke. The first valve member 324′ is arranged to cooperate with the first restriction arrangement such that the flow of damping medium from the first actuator chamber Vip32 to the pilot chamber 21 flows via the first flow path when the first valve member 324′ is in the first end position. The first valve member 324′ is further arranged to cooperate with the first restriction arrangement such that the flow of damping medium from the first actuator chamber Vip32 to the pilot chamber 21 flows via the second flow path when the first valve member is in the second end position. The flow of damping medium flows from the first actuator chamber via the first or second flow paths to a pilot chamber portion 400 which is in fluid communication with the pilot chamber 21.

In FIG. 6a, a first sub valve arrangement comprising a first valve member 324′ is shown, wherein the first valve member is in a first end position. When the first valve member 324′ is in the first end position during the first stroke, the first valve member 324′ abuts a first seat of the first sub-valve arrangement which thereby closes the first actuator chamber against the second chamber DC1Pc. In this case, the first valve member cooperates with the first restriction arrangement by unblocking the first channel 326′ when the first valve member is in the first end position, i.e. during the first stroke, thereby allowing a flow of damping medium to flow between the first actuator chamber Vip32 and the pilot chamber 21 via the first channel 326′ and the second channel 326 in parallel. Because the first flow restriction area is substantially larger than the second flow restriction area, the flow through the first channel 326′ will dominate, i.e. the flow through the second channel 326 will be negligible in comparison with the flow through the first channel 326′. The first flow path thus comprises or is formed by the first channel 326′ and the second channel 326 in parallel. The first flow restriction area can thus be approximated by the flow restriction area of the first channel 326′. In other words, the flow of damping medium from the first actuator chamber Vip32 to the pilot chamber 21 flows via said first flow path. Furthermore, the first valve member 324′ blocks a flow passage 330 between the second chamber DC1Pc and the first actuator chamber Vip32 when it is in the first end position. Thus, when the first valve member 324′ is in the first end position, the first actuator chamber Vip32 is not in fluid communication with the second chamber DC1Pc.

In FIG. 6b, the first valve member 324′ is in a second end position. When the first valve member 324′ is in the second end position, i.e. during the second stroke, the first valve member 324′ blocks the first channel 326′, thereby allowing a flow of damping medium to flow between the first actuator chamber Vip32 and the pilot chamber 21 via the second channel 326 only. Because the flow restriction area of the second channel 326 is substantially smaller than the flow restriction area of the first channel 326′, the flow is more strongly restricted compared to when the first valve member 324′ is in the first end position. The second flow path thus comprises or is formed by the second channel 326. The second flow restriction area is thus equal to the flow restriction area of the second channel 326. Furthermore, the first valve member 324′ unblocks the flow passage 330 between the second chamber DC1Pc and the first actuator chamber Vip32 when it is in the second end position. Thus, when the first valve member 324′ is in the second end position, the first actuator chamber Vip32 is in fluid communication with the second chamber DC1Pc.

As mentioned above, when the first valve member 324′ is in the first end position, the first valve member 324′ is arranged to unblock the first channel 326′. The flow is thus approximately restricted by the flow restriction area of the first channel 326′. When the first valve member 324′ is in the second end position, the first valve member 324′ is arranged to block the first channel 326′. The flow of damping medium from the first actuator chamber Vip32 is thereby forced through the second channel 326 to the pilot chamber 21. The flow is thus restricted by the restriction area of the second channel 326.

It is understood that a corresponding arrangement as illustrated in FIGS. 6a and 6b and described above may be used in the other flow direction analogously with FIG. 2. In another embodiment, an arrangement as illustrated in FIGS. 3a and 3b and described above may be used in one flow direction, i.e. for restricting a flow from a first actuator chamber to the pilot chamber, and a fixed restriction arrangement may be used for in the other flow direction, i.e. for restricting a flow from a second actuator chamber to the pilot chamber.

Although exemplary embodiments of the present invention have been shown and described, it will be apparent to the person skilled in the art that a number of changes and modifications, or alterations of the invention as described herein may be made. Thus, it is to be understood that the above description of the invention and the accompanying drawing is to be regarded as a non-limiting example thereof and that the scope of the invention is defined in the appended patent claims.

1-31. (canceled)

32. A valve arrangement for controlling a main flow of damping medium in a shock absorber, the valve arrangement comprising:
a first actuator having a first actuator chamber communicating with a first damping chamber and a second damping chamber, the first actuator configured to actuate on the main flow of damping medium during a first stroke in response to a first actuating pressure in the first actuator chamber;
a pilot valve configured to control the first actuating pressure, the pilot valve having a pilot chamber in fluid communication with the first actuator chamber;
a first restriction arrangement for restricting a flow of damping medium from the first actuator chamber to the pilot chamber, the first restriction arrangement configured to provide a first flow path restricted by a first flow restriction area during a first stroke and to provide a second flow path restricted by a second flow restriction area during a second stroke; and
a first sub valve arrangement having a first valve member, the first valve member being in a first end position during the first stroke and being in a second end position during the second stroke, wherein the first valve member is configured to cooperate with the first restriction arrangement such that the flow of damping medium from the first actuator chamber to the pilot chamber flows via the first flow path when the first valve member is in the first end position and flows via the second flow path when the first valve member is in the second end position.

33. The valve arrangement of claim 32, wherein the first valve member is configured to cooperate with a channel portion of the first restriction arrangement.

34. The valve arrangement of claim 33, wherein the first flow path comprises a first channel and a second channel between the first actuator chamber and the pilot chamber and the second flow path comprises the second channel between the first actuator chamber and the pilot chamber, wherein the first channel and the second channel are arranged in parallel and the first valve member is configured to block the first channel when the first valve member is in the second end position.

35. The valve arrangement of claim 34, wherein the first valve member is movable between a second channel opening defining the first end position and a first channel opening defining the second end position.

36. The valve arrangement of claim 35, wherein the first valve member is a rounded element configured to block the second channel opening when the first valve member is in the first end position and to block the first channel opening when the first valve member is in the second end position.

37. The valve arrangement of claim 33, wherein the first flow restriction area is defined by a first channel portion and the second flow restriction area is defined by a second channel portion, wherein the first channel portion and the second channel portion are arranged in series between the first actuator chamber and the pilot chamber, and wherein the first valve member is configured to bypass the second channel portion when the first valve member is in the first end position and to force the flow of damping medium from the first actuator chamber to the pilot chamber via the second channel portion when the first valve member is in the second end position.

38. The valve arrangement of claim 37, wherein the first valve member comprises a flexible portion forming a channel wall portion movable between the first and the second end positions to vary a flow restriction area.

39. The valve arrangement of claim 38, wherein the first valve member is a shim.

40. The valve arrangement of claim 39, wherein the first sub valve arrangement is a first shuttle valve, wherein the first valve member abuts a first seat when the first valve member is in the first end position and the first valve member abuts a second seat when the first valve member is in the second end position.

41. The valve arrangement of claim 40, wherein the first flow restriction area is greater than the second flow restriction area.

42. The valve arrangement of claim 41, wherein the first actuator comprises two or more plungers configured to actuate on the main flow of damping medium in response to the first actuating pressure.

43. The valve arrangement of claim 41, wherein the second actuator comprises an annular actuator configured to actuate on the main flow of damping medium in response to the second actuating pressure.

44. The valve arrangement of claim 42 further comprising a first main valve member located between the first actuator and the first seat part, wherein the first main valve member is configured to open and close against the first seat part to allow the main flow of damping medium to pass from the first damping chamber to the second damping chamber.

45. The valve arrangement of claim 44 further comprising:
a second actuator having a second actuator chamber communicating with the first damping chamber and the second damping chamber, the second actuator configured to actuate on the main flow of damping medium during a second stroke in response to a second actuating pressure in the second actuator chamber;
a second restriction arrangement for restricting a flow a damping medium from the second actuator chamber to the pilot chamber, the second restriction arrangement configured to provide a third flow path restricted by a third flow restriction area during the first stroke and to provide a provide a fourth flow path restricted by a fourth flow restriction area during the second stroke;
a second sub valve arrangement having a second valve member, the second valve member being in a first end position during the second stroke and being in a second end position during the first stroke, wherein the second valve member is configured to cooperate with the second restriction arrangement such that the flow of damping medium from the second actuator chamber to the pilot chamber flows via the third flow path when the second valve member is in the first end position and flow via the fourth flow path when the second valve member is in the second end position; and
wherein the pilot valve is configured to control the first actuating pressure and the second actuating pressure and wherein the pilot chamber is in fluid communication with the first actuator chamber and the second actuator chamber.

46. The valve arrangement of claim 45, wherein the second valve member is configured to cooperate with a channel portion of the second restriction arrangement.

47. The valve arrangement of claim 46, wherein the third flow path comprises a third channel and a fourth channel between the second actuator chamber and the pilot chamber and the fourth flow path comprises a fourth channel between the second actuator chamber and the pilot chamber, wherein the third channel and the fourth channel are arranged in parallel and the second valve member is configured to block the third channel when the second valve member is in the second end position.

48. The valve arrangement of claim 47, wherein the second valve member is movable between a fourth channel opening defining the first end position and a third channel opening defining the second end position.

49. The valve arrangement of claim 48, wherein the second valve member is a rounded element configured to block the fourth channel opening when the first valve member is in the first end position and to block the third channel opening when the first valve member is in the second end position.

50. The valve arrangement of claim 46, wherein the third flow restriction area is defined by a third channel portion and the fourth flow restriction area is defined by a fourth channel portion, wherein the third channel portion and the fourth channel portion are arranged in series between the second actuator chamber and the pilot chamber and wherein the second valve member is arranged to bypass the fourth channel when the second valve member is in the first end position and to force the flow of damping medium from the second actuator chamber to the pilot chamber via the fourth channel when the second valve member is in the second end position.

51. The valve arrangement of claim 50, wherein the first valve member comprises a flexible portion forming a channel wall portion movable between the first and the second end positions to vary a flow restriction area.

52. The valve arrangement of claim 51, wherein the first valve member is a shim.

53. The valve arrangement of claim 52, wherein the second sub valve arrangement is a second shuttle valve and wherein the second valve member abuts a third seat when the second valve member is in the first end position and the second valve member abuts a fourth seat when the second valve member is in the second end position.

54. The valve arrangement of claim 53, wherein the third flow restriction area is greater than the fourth flow restriction area.

55. The valve arrangement of claim 54, wherein the second actuator comprises two or more plungers configured to actuate on the main flow of damping medium in response to the second actuating pressure.

56. The valve arrangement of claim 54, wherein the second actuator comprises an annular actuator configured to actuate on the main flow of damping medium in response to the second actuating pressure.

57. The valve arrangement of claim 54 further comprising a second main valve member located between the second actuator and a second seat part, wherein the second main valve member is configured to open and close against the second seat part to allow the main flow of damping medium to pass from the second damping chamber to the first damping chamber.

58. The valve arrangement of claim 57 further comprising at least 2 plungers and not more than 13 plungers arranged in a circle around a valve center wherein the plungers are guided in a plunger housing.

59. The valve arrangement of claim 58, wherein the two or more plungers are configured to exert an actuator force on the valve disk in response to a pilot pressure, wherein the actuator force may be varied by varying at least one of a diameter size of the plunger and the number of plungers.

60. The valve arrangement of claim 59, wherein the two or more plungers are configured to be individually movable relative to each other in order to generate an actuator force to tilt the first valve member and the second valve member such that friction and stick slip can held to low levels.

61. The valve arrangement of claim 60, wherein the first actuator and the second actuator further comprise springs configured with different preload and spring rates in order to provide a spring force action such that the first valve member and the second valve member are controllable in a plurality of ways to obtain a plurality of different tilting patterns to increase the freedom to select valve characteristics at low pilot pressures.

62. The valve arrangement of claim 61, wherein the first stroke is one of a compression stroke and a rebound stroke of the shock absorber and the second stroke is the other of the compression stroke and the rebound stroke.
